(19) United States
(12) Patent Application Publication
(10) Pub. No.: US 2008/0049199 A1
(43) Pub. Date: Feb. 28, 2008

(54) Slide projector with multiple projection sections

(76) Inventor: Wan-Chu Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,428

(22) Filed: Aug. 22, 2006

(51) Int. Cl. G03B 23/00

(52) U.S. Cl. 353/103

(57) ABSTRACT

The invention relates to an improved slide projector with multiple projection sections, which includes at least two lighting sources controlled by an IC therein. The projector has a head with multiple projection sections on its lens and a slot for receiving a slide, which is provided with multiple drawings relating to a lighting source. The slide projector can provide an action projection shows when the lighting sources are lightened in series that obtains a utilized effect.

### BACKGROUND OF THE INVENTION

A conventional slide projector always has a single light source to provide a single static projection show of a slide. Another slide provided in the projector obtains another static projection show. It is somehow monotonous. In other word, it is necessary to change the slide for projecting different projection show and this is very trouble and inconvenient.

### SUMMARY OF THE INVENTION

It is an object of the present invention to provide an improved slide projector with multiple projection sections, which includes several lighting sources for projecting different sections to display related projection shows. Now, accompanying with the following drawings, the character of the present invention will be described here and after.

### BRIEF DESCRIPTION OF THE DRAWINGS

FIG. 1 is a side plan view showing a slide projector with multiple projection sections according to the present invention.

FIG. 2 is a front plan view showing a projection lens according to the present invention.

FIG. 3 is a perspective view showing the slide projector with a projection slide according to the present invention.

FIG. 4 is an assembled view of FIG. 3.

### DETAILED DESCRIPTION OF THE PREFERRED EMBODIMENT

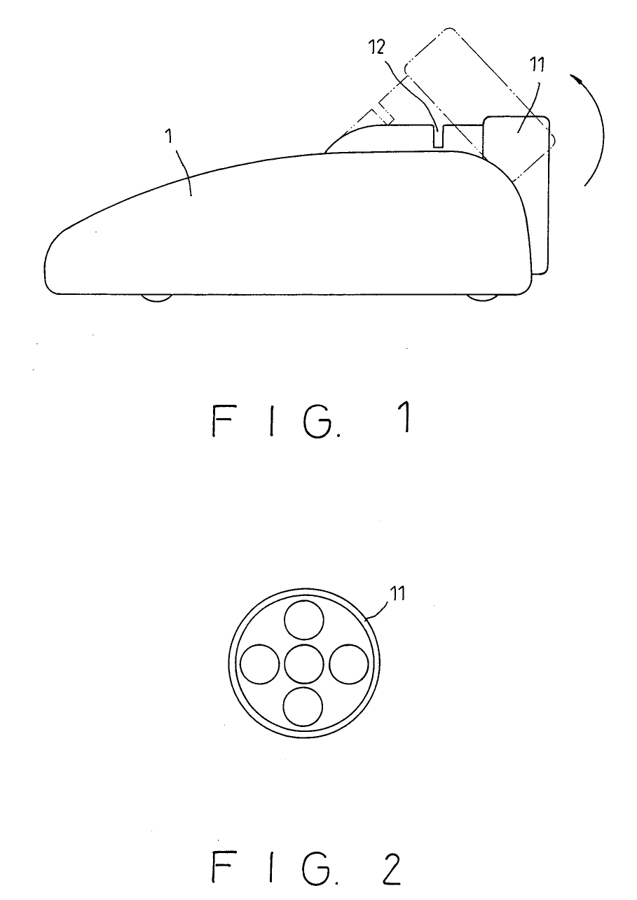

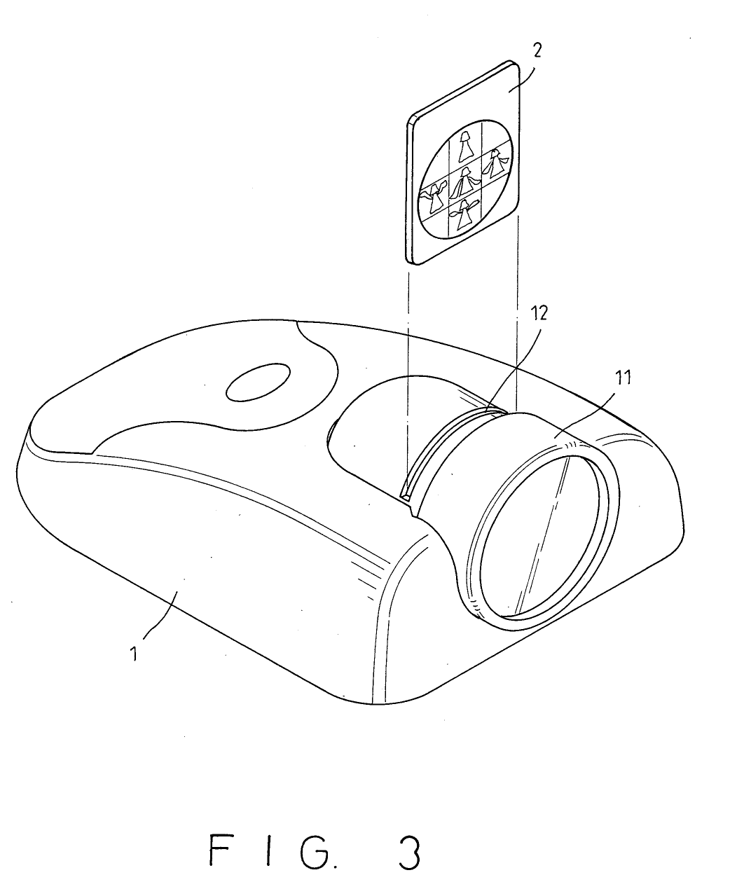

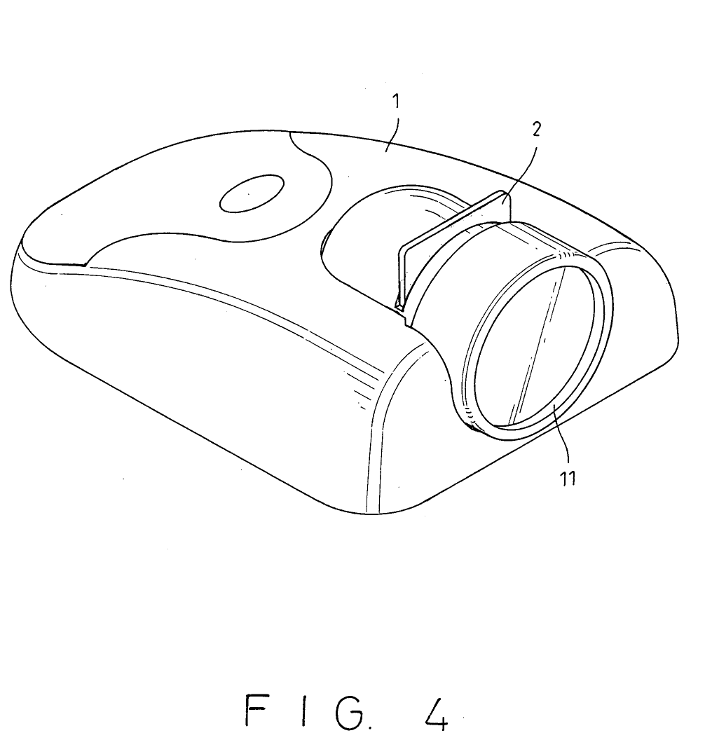

Referring to FIG. 1 to 4, the present invention relates to a slide projector (1) with multiple projection sections, which includes a projection head (11) having a lens being provided at least two sections. For description in this embodiment, it is formed five projection sections. There are the same numbers (five) of lighting sources provided in the slide projector (not shown), which has a same structure as a prior art and will not be described in detail here. A slot (12) is formed on the projection head (11) for receiving a slide (2), which has several (five) independent drawings in related areas. Each area is placed related to a lighting source in the projector (1) and the lighting sources can be controlled by an IC for being lightened serially.

In use, the slide (2) is inserted into the slot (12) of the projector (1). When a lighting source is lightened, a related drawing of the slide (2) will be projected respectively. Hence, if the lighting sources are controlled in a certain series, the projection shows become a changing figures, which seems a moving action that reaches an effect being better than ever.

In FIG. 1, it includes imaged lines to show that the projection head (11) is adjustable for projecting projection show on a suitable angle or place.

Accordingly, the slide projector can provide a changing projection shows in a same slide. Hence, the present invention obtains improved utilization and should be allowed for a patent.

I claim:

1. A slide projector with multiple projection sections including a projection head having a lens being provided at least two sections, the same numbers of lighting sources provided in the slide projector, a slot formed on the projection head for receiving a slide, which has same numbers of independent drawings in related areas on a lens of the projection head.

2. A slide projector with multiple projection sections as claimed in claim 1, wherein the lighting sources are controlled by an IC for being lightened in a certain series to provide projection shows changed in series as a moving figure.

3. A slide projector with multiple projection sections as claimed in claim 1, wherein the projection head of the slide projector is adjustable.
